(19) United States
(12) Patent Application Publication
(10) Pub. No.: US 2005/0267807 A1
(43) Pub. Date: Dec. 1, 2005

(54) Integrated automatic innovation infrastructure

(76) Inventor: Alfred Y. Bentley III, Montclair, NJ (US)

Correspondence Address: Whitham, Curtis, & Christofferson, P.C., Suite 340, 11491 Sunset Hills Road, Reston, VA, 20190, US

(21) Appl. No.: 11/138,281

(22) Filed: May 27, 2005

Related U.S. Application Data
(60) Provisional application No. 60/574,943, filed on May 28, 2004.

(51) Int. Cl. G06F 17/60

(52) U.S. Cl. 705/14; 705/1

(57) ABSTRACT

An integrated autonomic innovation infrastructure including an autonomic management system, a motivational signature management system and/or an innovation signature management system manages all aspects of innovation activity for an organization including maintaining a record of submissions of innovation and development thereof including support of collaboration, matching problems with solutions and review and evaluation thereof, management of employee motivation through matching of incentives to innovation and supporting optimal deployment of individuals within an organizational structure to support creative and innovative activity as well as handling consideration and collaboration in regard to submissions in regard to improvements in the infrastructure, itself. numerous feedback paths in each system and between systems allow adaptive optimization of each of the systems and the integrated infrastructure.

### CROSS-REFERENCE TO RELATED APPLICATIONS

This application claims priority of U.S. Provisional Patent Application 60/574,943, filed May 28, 2004, which is hereby fully incorporated by reference. This application is also related to U.S. patent application Ser. Nos. 10/______, 10/______ and 10/______ (Attorney Docket Numbers YOR920040162US1, YOR920040163US1 and YOR920040164US1, respectively) which are filed concurrently herewith and assigned to the assignee of the present invention and also fully incorporated by reference.

### BACKGROUND OF THE INVENTION

1. Field of the Invention

The present invention generally relates to systems and techniques for managing innovation within a business, organization or enterprise and in particular systems and techniques for using the human and infrastructural resources thereof to optimize the management of novel ideas, needs and opportunities.

2. Description of the Prior Art

Prior art systems offer products that help a company take in new ideas, enable review of and collaboration on these ideas, and track the progress of these ideas through the company from inception to development to implementation. It is also often desirable to track the contributions of various individuals for both legal documentation and employee recognition purposes. Such employee recognition and a substantially static incentive policy have been used to motivate the creation and development of ideas but may not optimally support the management of all factors involved for optimal utilization of knowledge and creative talent resources underlying the development of innovation within a business, organization or enterprise (e.g. company, university, non-profit entity or the like).

U.S. Patent Application Publication 2003/0187706 to Buchmiller et al. describes an enterprise-wide knowledge management system, which includes an engine portal that can link each user to any needed expertise, throughout an enterprise, in a consistent manner, thereby freeing enterprise experts to pursue activities having a potentially higher value-added to enterprises of the company, in general, and more consistent with the specific expertise of individual experts. The entire innovation life cycle is made accessible to all employees, from the initial demand for innovation, through the searches for innovation, sparking of innovation creations, innovation collaborations and investments, and innovation reporting and communications. The enterprise-wide knowledge management system provides a system of business processes and tools, which are designed to collect, enhance, and leverage the organization's intellectual capital. However, the communications provided by this system are not necessarily optimized for any particular technology or business organization and do not appear to be readily modified nor do they support optimal management and/or motivation of creative personnel.

U.S. Patent Application Publication 2003/0036947 to Smith et al. describes systems and techniques for managing the submission of ideas in an organization. Ideas are collected and entered into an electronic archive accessible through a network, and then displayed so that the members of the organization can provide additional thoughts related to the submission. The ideas are then provided to a management screening committee for screening. The screened ideas are then submitted to an idea sponsor. This is followed by an opportunity screening phase, in which the submitted, screen ideas are further developed and evaluated. An idea submission tool is provided for web-based submissions. However, the principal thrust of this system is to enhance communications for idea development and to prevent idea loss.

U.S. Pat. No. 6,411,936 to Sanders describes an enterprise value enhancement system that uses an enterprise value enhancement model based on planning loop structures. The system receives field feedback input from users in response to surveys generated by a field feedback survey generator. A switchboard in the system sends this feedback, as well as data from one or more databases, to parts of the system including a performance processor, a customer asset valuation processor, a performance metrics engine, and a value enhancement solution generator, which generates value enhancement solutions for the enterprise. The system focuses on value enhancement of an enterprise rather than on only one specific aspect or area, such as marketing, finance or strategy. While a process for evaluation of an employee contribution chain is disclosed, it appears to be based on qualitative and subjective estimations of aspects of employee performance.

U.S. Pat. No. 5,924,072 to Havens describes a computer-based knowledge management system that receives submitted knowledge items, maintains and provides access to these items, updates these items as appropriate, prompts for and receives feedback relating to the items, monitors various activities concerning the items, and generates a variety of incentives to encourage desirable activities associated with the items. The incentives for desirable knowledge worker activities are stored in activity records that represent different perspectives from which information related to knowledge items may be viewed, appreciated, and applied to benefit the organization. Using appropriate incentives, the behavior of knowledge workers within the organization may be channeled in such a way that total intellectual capital is maximized. The information accumulated in the activity records may be used for assessing the productivity, contribution, and performance of knowledge workers, thereby providing a basis for evaluating compensation, seniority, or other aspects of the relationship between the knowledge workers and the organization. However, this system does not provide for the evaluation of the effectiveness and adaptive modification of the current incentives which it supports for individuals or groupings of individuals who may be differently motivated for different activities and at different times.

U.S. Patent Application Publication 2004/0054545 to Knight describes a system and method for managing innovation capabilities of an organization by storing one or more quantitative values associated with one or more innovation capabilities, each of which is associated with one of a plurality of innovation levels. The method includes identifying an innovation capability having a quantitative value associated with an innovation level that falls below an expected innovation level value. The method identifies solutions operable to increase the innovation level associated with the quantitative value. However, these functions and evaluations appear to be approached only at the organization level.

U.S. Patent Application Publication 2003/0158745 to Katz et al. describes a system for documenting, tracking and facilitating the development of intellectual property, allowing a company to maintain a dynamic network database of intellectual capital. Entries in the database are stored on individual computers. Searches are conducted by transmitting a search request to each computer on the network. The system facilitates the development of intellectual capital when the members of the development team are not in the same location by providing methods of communication, scheduling, sharing files and searching for additional team members.

U.S. Patent Application Publication 2003/0083898 to Wick et al. describes a system and method for monitoring intellectual capital using a metrics engine and a dashboard. The metrics engine is operable to receive a request associated with a metric, identify data associated with the request, retrieve data based on the identified data and process the data based on the requested metric. The dashboard is operable to graphically display the provided data.

U.S. Patent Application Publication 2002/0091543 to Thakur describes a method for acquiring, evaluating, patenting, and marketing innovation by receiving inventions submitted by innovators. Descriptions of the inventions are collected, categorized and evaluated. A database containing the evaluated descriptions is made available to potential users or customers of the inventions. The customers can review the inventions by category, or by searching for solutions to problems they would like to solve. Once an invention is identified, the customers can review evaluations including technical feasibility, commercial feasibility and patentability feasibility. A facilitator serves as an arbitrator between innovators and customers for the intellectual property in question. Licenses are also available, and the facilitator may take a percentage of any licenses concluded.

U.S. Pat. No. 5,879,163 to Brown, et al. describes an on-line health education and feedback system using motivational driver profile coding and automated content fulfillment to provide customized health education to an individual at a remote terminal to induce a modification in a health-related behavior of the individual. The automated system includes a questionnaire generator for questioning the individual to determine his or her motivational drivers and comprehension capacity. A profile generator receives answers entered by the individual from the remote terminal and generates a motivational driver profile and a comprehension capacity profile of the individual. A translator receives clinical data relating to a current health condition of the individual and translates the clinical data, the motivational driver profile, and the comprehension capacity profile into a profile code. An educational fulfillment bank matches the profile code to matching educational materials and transfers the matched educational materials to the remote terminal.

U.S. Pat. No. 6,769,013 to Frees, et al. discloses a distribution management system that can create a collaborative environment for members of a team by facilitating synchronous and asynchronous communications, taking advantage of electronic scheduling tools, supporting a facilitator paradigm, and storing meeting communications for later retrieval over a computer network. An interactive forum can be provided in the collaborative environment in a manner offering varying degrees of structure for collecting information from the members of the team. The information can then be used to arrive at a collaboratively derived decision.

In addition to the foregoing patents, there are a number of commercial products that support innovation management. Of these, three are pertinent to the present invention: IdeasTracker, Imaginatik, and JPB.com. The IdeasTracker knowledge platform is a web-based resource for companies to manage their ideas, knowledge and information, from anywhere. The IdeasTracker platform allows a company to gather ideas, peer review submissions, shared ideas, and create a central database of ideas. This product is similar to other on-line idea suggestion programs. However, this program requires a moderator to approve an idea for submission. IdeasTracker can be run within the corporation or be centrally located.

The Imaginatik system is an on-line idea suggestion and collaboration system. Imaginatik's idea management software product suite consists of Idea Central, Idea Chain, and additional add-on modules such as: Portal Module, Rewards Module, Idea Warehouse and External Access Module. The Idea Central product is designed to collect ideas from employees, and contains the core functionality of the Idea Management process, such as idea collection, idea development, evaluation, idea browsing and search, and collaboration and workflow capabilities. The Idea Chain product is designed to manage the collection and development of ideas from external partners, such as suppliers, customers and research partners. Idea Chain is based on Idea Central and includes additional features to manage access rights, intellectual property rights, and controlled collaboration. The portal module allows the client to publish educational and general communications about the program. The Rewards Module is used to establish a points-based recognition system. The idea warehouse is a shared common repository of ideas from the corporation. The External Access Module allows for access to the system from outside the corporation.

The JPB.com suite of idea management products enables on-line submission, collaboration/review, and evaluation of ideas. The suite consists of Jenni Enterprise Idea Management, Sylvia Web Brainstorm, and Alice Suggestion Box. The Jenni Enterprise Idea Management product enables an organization to contribute ideas, collaborate, and monitor impact and performance. This platform also provides an evaluation tool that helps send ideas to the appropriate experts for completion. This product also features: idea management, implementation management, category management, user management, home page management and points management. The Sylvia product platform is used for brainstorming followed by evaluation and ranking of the ideas generated. The Alice Suggestion Box platform allows customers to contribute suggestions which can later be ranked and evaluated based on the same methodologies as above.

In summary, the foregoing prior art systems do not address the often static and non-adaptive management infrastructures which constrain the effectiveness of these systems. Furthermore, they do not track or adapt to the varied incentives which drive participants in such systems, nor do they respond to the particular contribution profiles of system participants. Consequently, these systems often do not perform as desired or support the concurrent and continuous management of innovation and the underlying creative talent and motivation for optimal performance of an arbitrary business environment.

### SUMMARY OF THE INVENTION

It is therefore an object of the present invention to provide a system and method for adapting the management structures of the enterprise to better leverage the ideas for innovations and process improvements generated by the members of the enterprise.

A further object of the invention is to provide a system and method for tracking and adapting to the varied incentives (sometimes referred to hereinafter as motivational drivers) which drive those contributing ideas for innovations and process improvements of value to the enterprise.

Another object of the invention is to provide a system and method of innovation management that is responsive to the particular contribution profiles of those participating.

A yet further object of the invention is to provide an innovation tracking and management system with plenary capabilities for not only optimally tracking, managing and documenting innovation development from inception to deployment but also optimizing both incentives toward contributions to all innovation being tracked and direction of efforts of innovative personnel to optimize their participation and the added value each individual participant brings to each innovation project.

In order to accomplish these and other objects of the invention, an integrated autonomic innovation infrastructure is provided comprising, in combination, an autonomic management system and infrastructure comprising an arrangement for inputting submissions in plural categories to the autonomic management system, at least one category of the plurality of categories relating to the infrastructure of the autonomic management system, and a feedback path for implementing submissions based on results of evaluation performed in one or both of the first and said second evaluation paths, and a motivational signature management system comprising an arrangement for developing a motivational signature from information regarding motivational drivers, an arrangement for collecting information regarding responses of individuals or groups of individuals to rewards presented upon completion of desired behavior, and a feedback path for refining said motivational signature with said information regarding said responses to rewards.

In accordance with another aspect of the invention, an integrated autonomic innovation infrastructure is provided comprising, in combination, an autonomic management system and infrastructure comprising an arrangement for inputting submissions in plural categories to the autonomic management system, at least one category of the plurality of categories relating to the infrastructure of the autonomic management system, and a feedback path for implementing submissions based on results of evaluation performed in one or both of a first evaluation path and a second evaluation path, and an innovation signature management system comprising an arrangement for developing an innovation signature for an individual from information representing innovation activity, innovative interests, motivational preferences and reward and survey records, a comparator for comparing the innovation signature with a definition of desired innovation activity, and a feedback path for the motivational driver information to the reward and survey records for said individual.

In accordance with a further object of the invention, a system for managing innovation within an enterprise is provided, comprising a basic innovation subsystem further comprising a subsystem for gathering ideas from users of said system, a subsystem for review of and collaboration on ideas by a community of said users, and a subsystem for tracking progress of said ideas through the enterprise from idea generation to idea implementation, an arrangement for developing and maintaining a motivational signature for each user, the motivational signature identifying an incentive structure optimized for the user, an arrangement for developing and maintaining an innovative signature for each user, the innovative signature providing a profile of contributions to the system by the user, and an autonomic management subsystem for using input from the community of users to adapt a process of the enterprise, the autonomic management subsystem further comprising an arrangement for using the idea gathering subsystem to survey the community of users regarding the value of the process and generate ideas for improving the process, an arrangement for determining whether one of the generated ideas for improving the process is to be implemented, discarded or deferred for possible future implementation, the determining arrangement further comprising an arrangement for using the review and collaboration subsystem to obtain from the community of users a valuation of the idea, the valuation indicating a likelihood that implementation of the idea will improve the process, and a recommendation that the idea be implemented, discarded or deferred; and an arrangement for using said review and collaboration subsystem to obtain from a designated subset of said community of users an expedited valuation of the idea, the valuation indicating a likelihood that implementation of the idea will improve the process, and an expedited recommendation that said idea be implemented, discarded or deferred, an arrangement for presenting the valuations and the recommendations to a management subset of said community of users for decision and an arrangement for receiving and storing the decision of the management subset of said community of users.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 is a conceptual diagram showing the operating cycle of the autonomic management system.

FIG. 2 is a conceptual diagram showing how motivational signatures are developed and revised.

FIG. 2A is a detail of FIG. 2, emphasizing inputs and feedback arrangements of the motivational signature management in accordance with the invention.

FIG. 3 is a chart showing the operation of components of the innovative signature system.

FIG. 3A is a detail of FIG. 3 including different categories of collected data to be used in developing innovation signatures.

FIG. 4 is a diagram showing overall operation of the constituent systems of the autonomic innovation infrastructure when integrated.

FIG. 4A illustrates a preferred enhancement of the processing of needs submissions in accordance with the invention.

FIG. 5 is a flowchart detailing an implementation of an autonomic management system.

FIG. 6 is a flowchart detailing the development and use of motivational signatures.

FIG. 7 is a flowchart detailing the development and use of innovation signatures.

FIG. 8 is a flowchart detailing an implementation of an autonomic innovation infrastructure.

FIG. 8A is a detailed illustration of the architecture of the innovation pipeline analyzer of FIG. 8.

FIG. 8B is a detailed illustration of the architecture of the pipeline manager of FIG. 8A.

### DETAILED DESCRIPTION OF A PREFERRED EMBODIMENT OF THE INVENTION

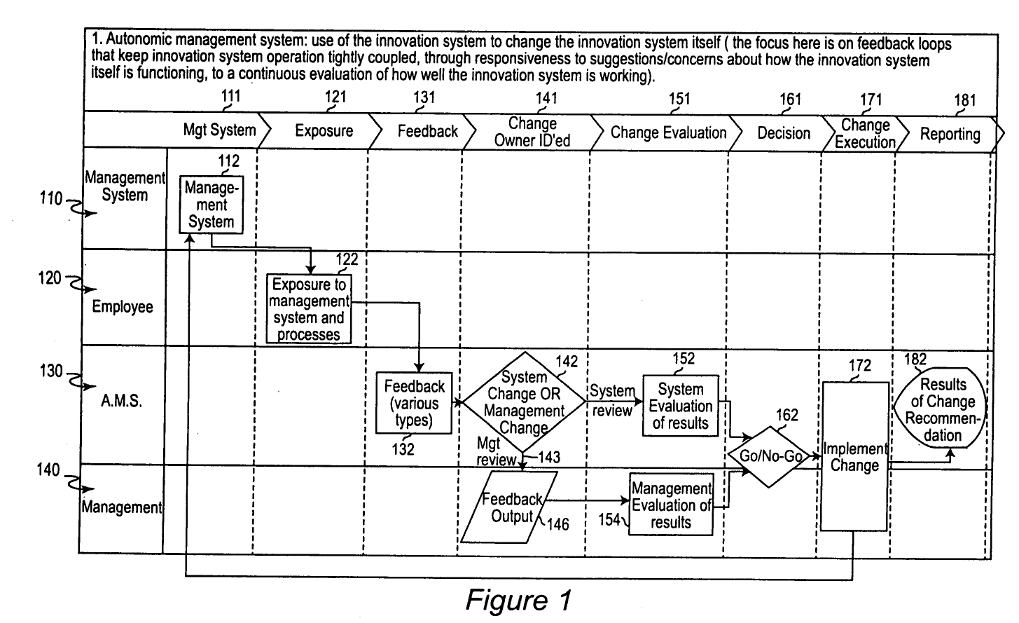

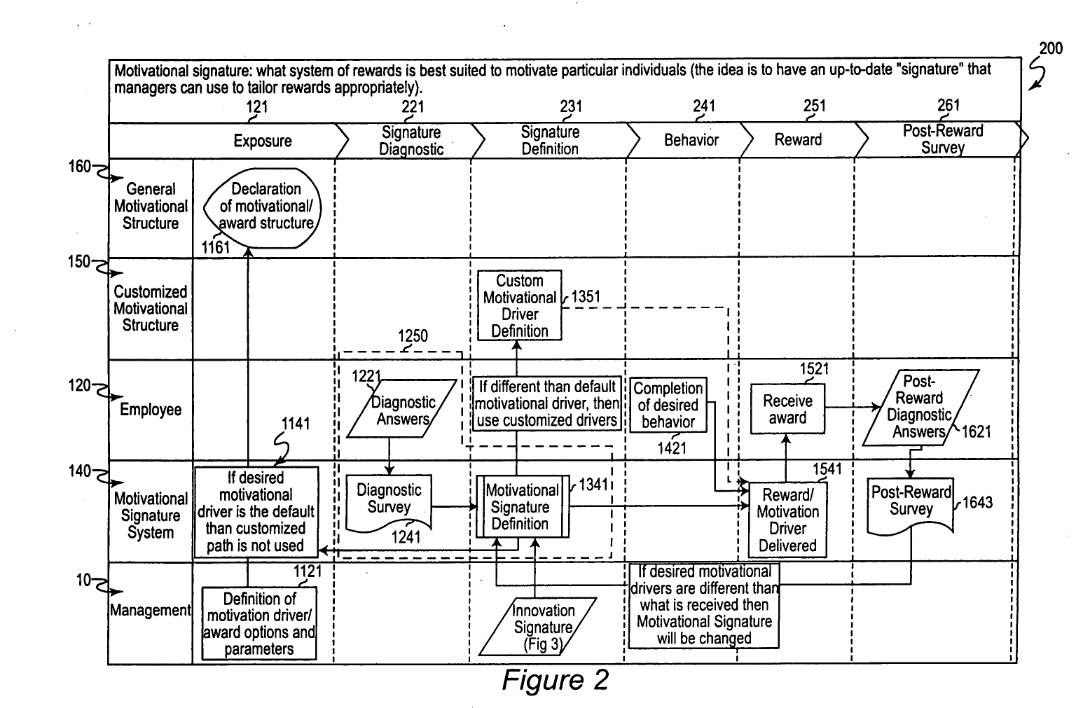

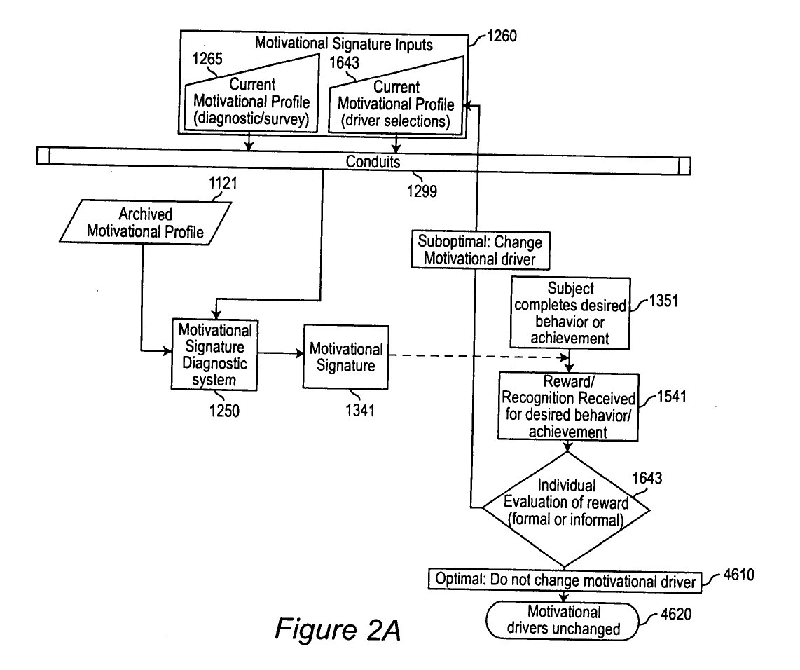

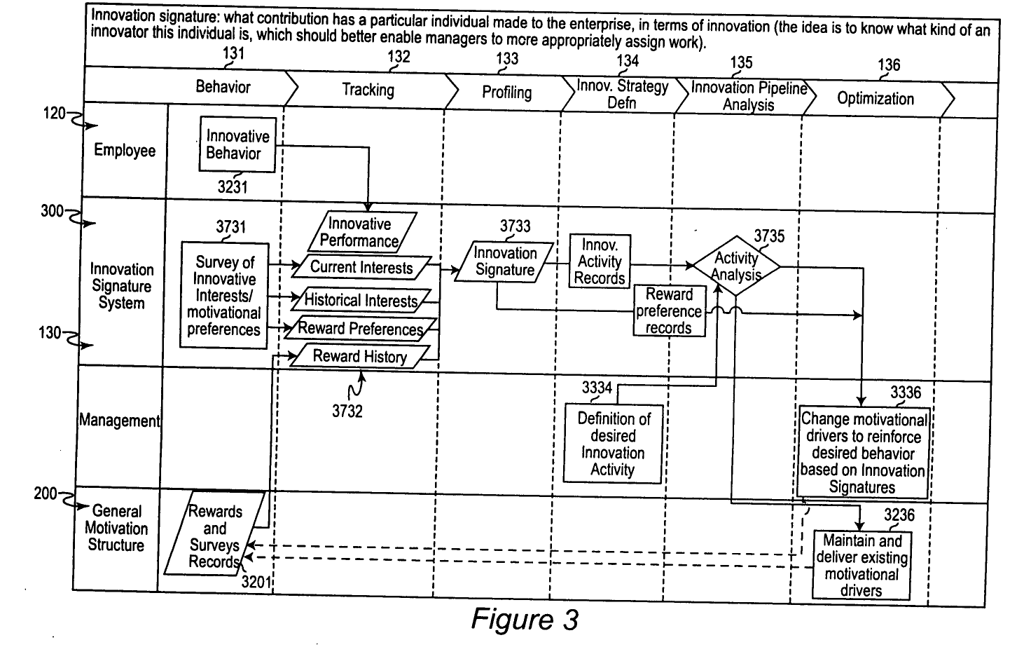

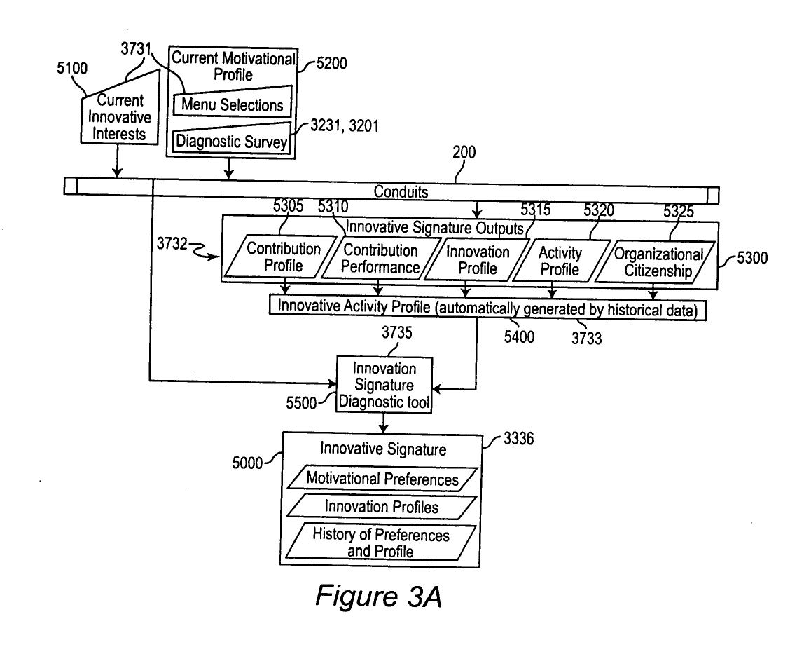

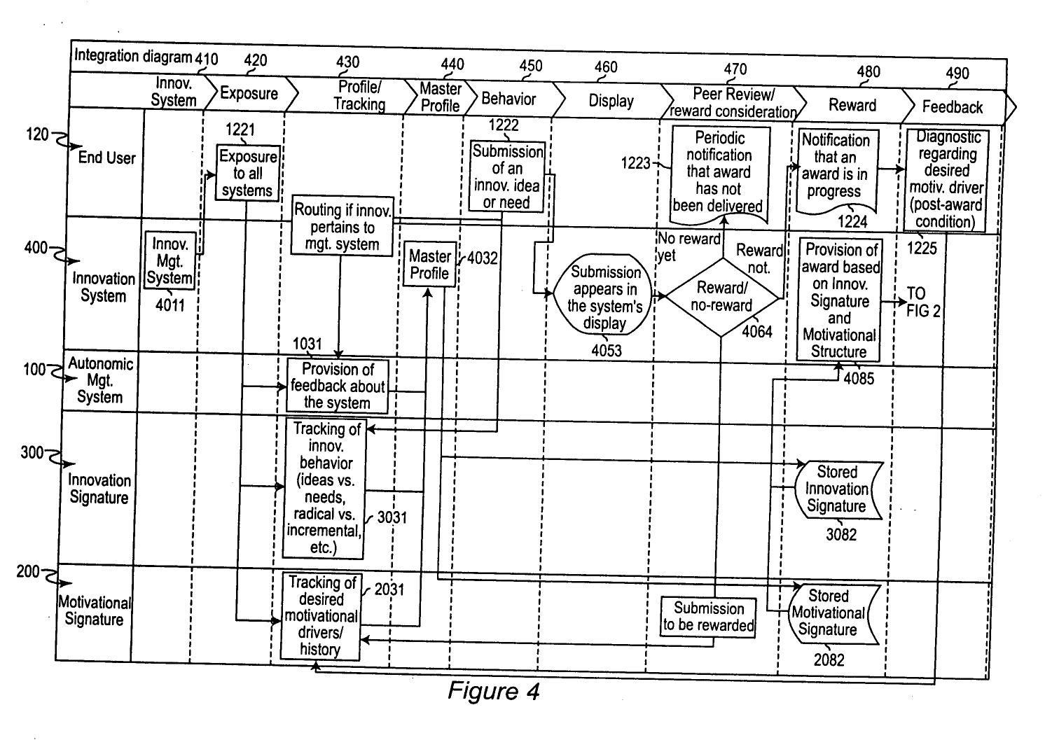

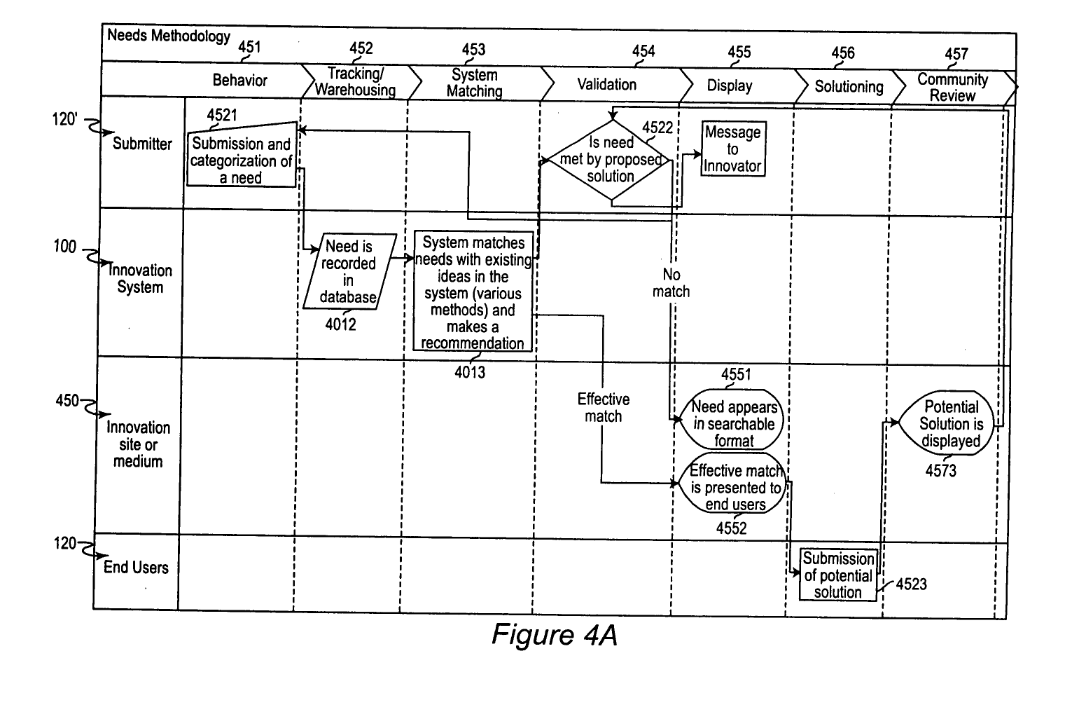

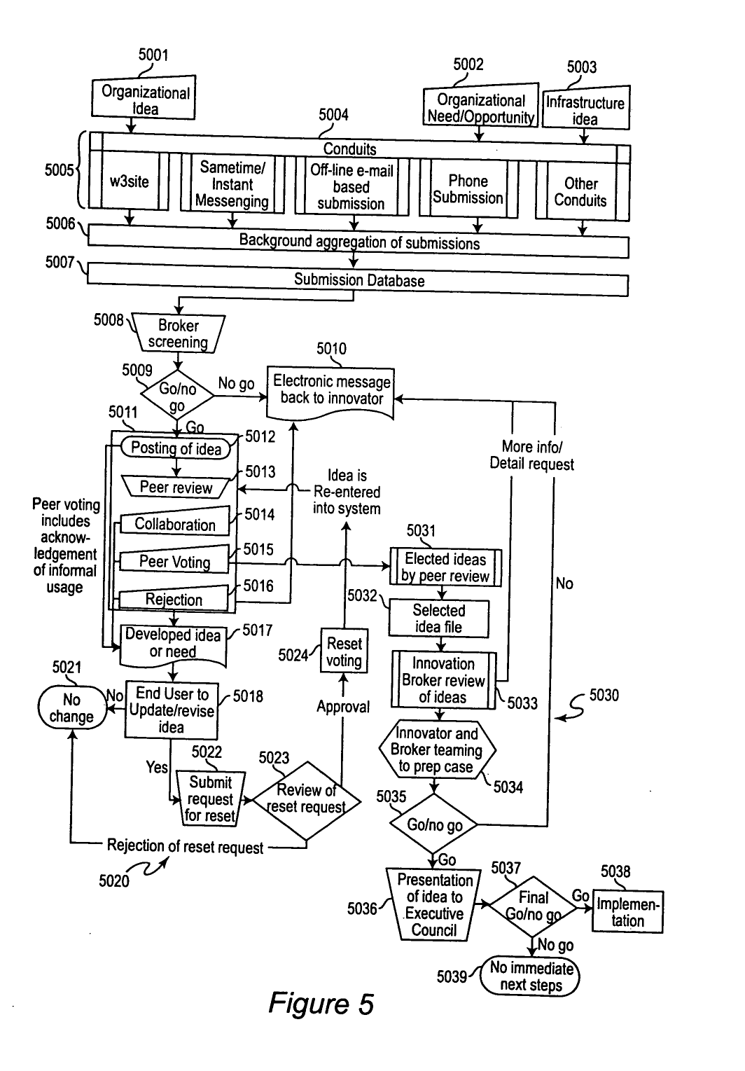

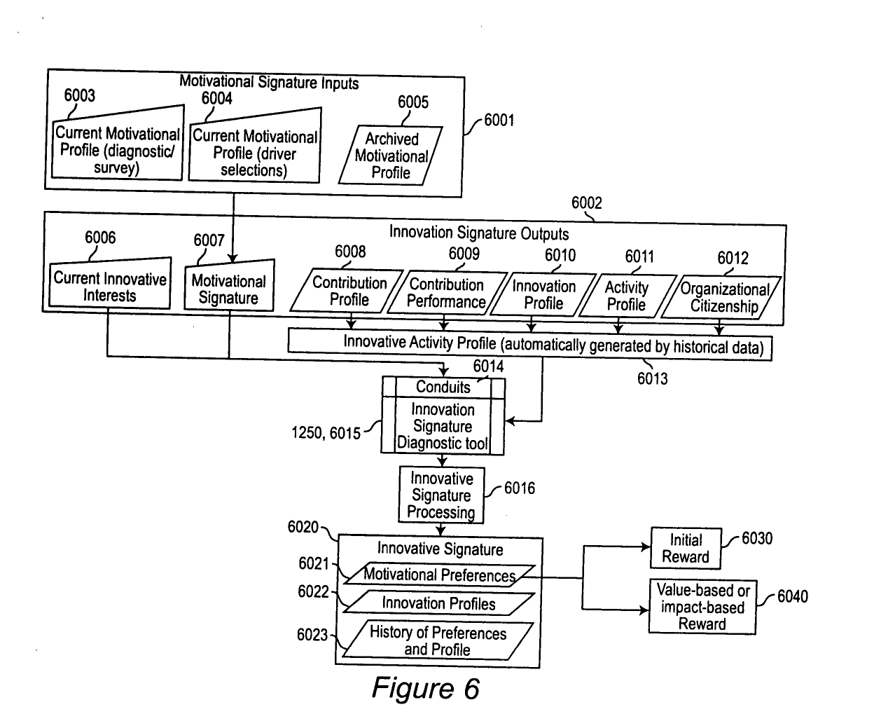

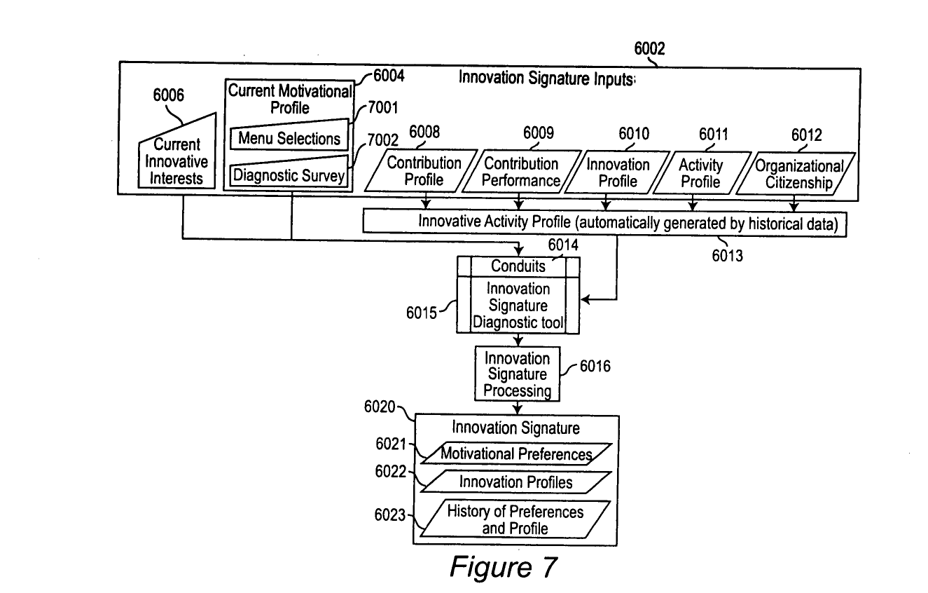

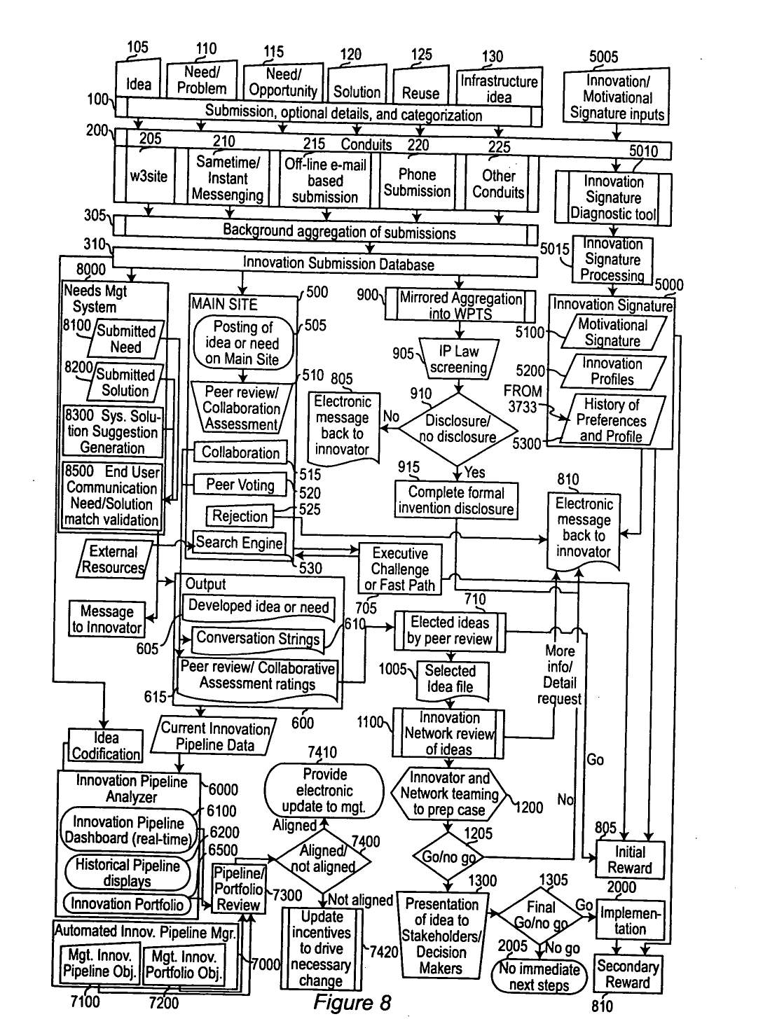

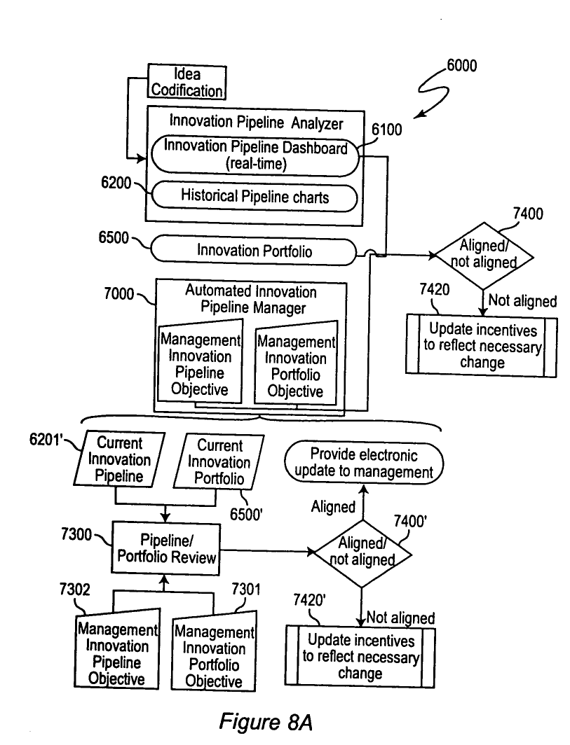

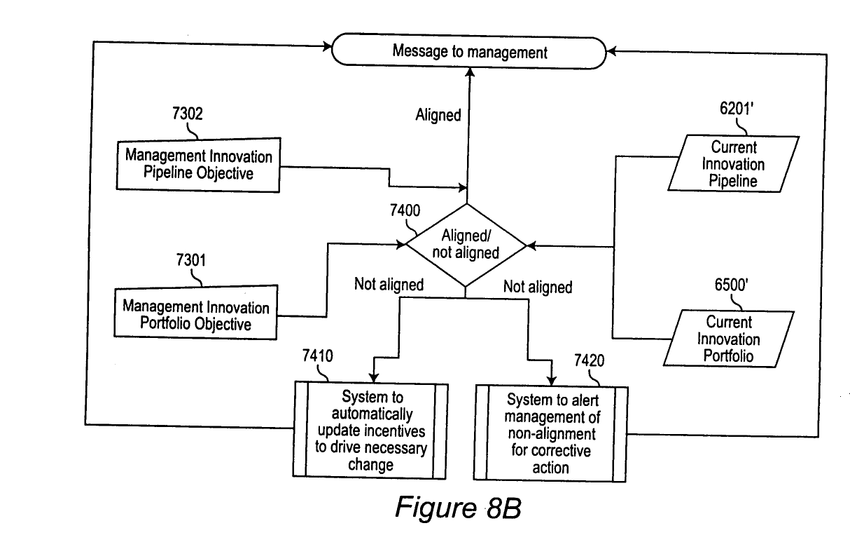

Referring now to the drawings, and more particularly to FIG. 1, there is shown a conceptual diagram showing the operating cycle of the autonomic management system in accordance with the invention. It should be understood that it is an important feature of the invention to allow and support optimal interaction of the invention with its environment, including but not limited to the management personnel and procedures of a business and incidents thereof, hereinafter collectively referred to as the overall or integrated AMS innovation management system (as distinct from the selectively autonomic, hence “autonomic”, management system provided by the invention or systems which can be used within the invention which provide for innovation management alone but which can be made adaptive and/or optimized in performance by use of the invention). Therefore, FIGS. 1-4, in order to convey an overview of the operations and interactions of the system and its constituent elements with its environment, depict such operations in a matrix form with the invention (AMS 100) and elements of its surrounding environment (e.g. management system 110, respective employees 120 and management for AMS control 130) depicted in respective rows and various stages of innovation development and external control of the invention depicted in respective columns. The architecture and operation flow of the invention to perform the functions and interactions depicted in FIGS. 1-4 will be detailed below with reference to FIGS. 5-8, respectively, all of which use commonly accepted shapes for operations depicted such as a parallelogram for input/output or a diamond shape for a decision, evaluation or branching operation. Thus, FIGS. 1 and 5 relate to the basic system of the autonomic management system (AMS) of the invention, FIGS. 2, 2A and 6 relate to the development and use of a motivational signature management system for optimizing employee participation and contribution, FIGS. 3, 3A and 7 relate to the development, use and management of an innovation signature for optimizing employee assignment and allocation in accordance with respective talent and expertise, and FIGS. 4 and 8 relate to integration of the basic AMS (with FIG. 4A relating to an enhancement thereof for handling needs submissions), with use and management of motivational and innovation signatures of respective employees to provide a comprehensive, adaptive system which effectively optimizes itself in an adaptive manner to provide maximal performance in regard to innovation management within a particular business with employees having differing talents and responses to motivation in regard to contributions to innovation and providing synergistic effects by utilizing adaptive capabilities of, for example, the innovation signature management system to enhance adaptive capabilities of, for example, the motivational signature management system to obtain increased enhancement of the overall, integrated system in accordance with the invention.

It will also be appreciated from FIGS. 1-4, in particular, that the invention provides interactions with business management and employees which model optimal business management practices and adaptively modify those practices interactively and in a fine-grained manner to continuously optimize performance of the system in accordance with the invention. Further, since the system in accordance with the invention is preferably executed using a data processor, the operations and adaptations thereof are performed in a consistent manner but allowing intervention upon due consideration by appropriate personnel and avoiding potential inconsistency of performance or adaptation which would be characteristic of attempts to perform such management manually. Of course, attempted manual performance would necessarily involve much increased personnel requirements to perform management with the consideration of the detail of which the invention is capable and such increase in personnel would necessarily compromise consistency of performance and be likely to have adverse effects on employee performance and morale.

FIG. 1 is intended to convey an understanding of the use of an innovation management system to provide adaptive change in that innovation management system. For that reason, the underlying management principles and particulars and details of the initial innovation management system employed is of relatively lesser importance since such principles, particulars and details can be adaptively changed in accordance with the invention. Thus, the emphasis in FIG. 1 is on the utilization of feedback loops and other utilization of feedback which maintains the innovation system tightly coupled through continuous responsiveness to suggestions or concerns about how the innovation management system, itself, is working.

At the management system stage of operation 111, it is assumed that the management system 110 is in a particular state 112 with certain principles and policies established, such as the initial state of a software innovation tracking system operating much in the manner of known systems discussed above, but having the capability for the principles and policies embodied in such software to be readily modified. The capability of providing such modification can be readily accomplished by, for example, conditioning certain actions of the result of dynamically evaluated expressions which can be altered to include, exclude or change weighting of particular qualitative or quantitative parameters or other expedients well-understood by journeyman computer programmers.

At the exposure operation stage 122. the current principles and policies are promulgated to employees 120; to which the employees may or may not provide various types of feedback in various forms (e.g. memos, responses to questionnaires, direct system input and the like). This feedback is provided to the AMS system of the invention 100 at 132 in the feedback stage of operation 131 and, in the following sponsor identification/owner of change ID stage of operation 141, the identity of the owner or originator of the feedback is determined and preferably categorized as to employee type (e.g. research, development, marketing or the like). It has been found in the course of experimental trials of the invention that employees having a particular type of function in the business operation or innovation enterprise may have radically different feedback responses and policy changes corresponding to different types of feedback responses may be useful in enhancing specific stages of the innovation inception, development and deployment of a particular product or improvement thereof due to differences in responses to motivational incentives.

It has also been found useful to discriminate whether the feedback is directed to a system (i.e. in the sense of management infrastructure) change or a innovation/management (i.e. in the sense of management of the innovation or management of the business in respect to the innovation) change or a combination thereof since aspects of the feedback respectively pertaining to the AMS system 100, itself, and the AMS management 130 are most efficiently and meaningfully handled in different ways. This discrimination is depicted in FIG. 1 as a branching operation 142 which provides one branch continuing in the AMS system 100 and another branch 143 providing feedback output 144 to the AMS management 130 (although, in theory, both branches can the concurrently taken).

Within the AMS system at the change evaluation operation stage 151, a system review is initiated and an evaluation of system results 152 is performed within the AMS system. Such an evaluation may involve the retrieval of historical data in regard to similar changes and the surrounding conditions most similar to the feedback data in order to project the effect of such a change by any of a number of known techniques such as perturbation analysis. In the AMS management element 130, essentially the same general type of analysis and evaluation 154 is performed but allowing intervention of management personnel charged with overseeing performance of the AMS system 100. In other words, the system can be enabled, within given parameters to make changes autonomously. If the change is outside those parameters, management review is required. (In view of the selectively autonomous operation of the invention, it is referred to as “autonomic”.) For example, the system can be programmed to make a change in the awards system to change award methodology whereas it is considered preferable in most cases, delineated by closely defined parameters, it is preferred to involve management/human intervention in infrastructure changes. This feature allows feedback which may require subjective judgement for proper evaluation to have that subjective judgement applied in projecting the magnitude of any benefit, if any, on the innovation management process and or evaluation of human factors such as effect on employee morale if, for example, the change is particularly radical or related to a change recently made that might indicate some degree of indecision on the part of the management of the business.

Depending on the result of such an evaluation, which can maximally consider possibly related factors in a maximally consistent manner due to the provision for both internal and external (to the AMS system) to the extent each may be appropriate to the subject matter of the feedback information. This aspect of the decision operation stage is depicted in FIG. 1 by placing go/no go decision operation 162 and the implement change operation 172 of the change execution stage of operation 171 in a location bridging the AMS system and AMS management elements of the invention and its environment. The change thus implemented, if any, is then fed back to management system 112 and the process continually repeated while the results of the change recommendation are reported in the reporting stage of operation 181 by, for example, display 182 of a comparison of results before and after the change. Thus it is seen that the invention is capable of adaptive modification responsive to management of the business and input from its employees while supporting both internal (e.g. automatic) and/or external (e.g. manual) evaluation of potential impact of any changes to be made as well as automatic and adaptive implementation, where appropriate.

Referring now to FIG. 2, the development and use of a motivational signature 200 will now be discussed. This aspect of the invention determines what system of awards/rewards is best suited to motivate particular individuals by maintaining an up-to-date motivational signature for each employee or groups of employees which managers can use to tailor rewards appropriately to provide the most effective incentives to contribute to innovation. It should be noted that the management element 110 and the employee element 120 of the environment of the invention described in FIG. 1 are also present in FIG. 1, as is the exposure stage of operation 121. The motivational signature element is specifically depicted as element 140 in FIG. 2. Additionally, a customized motivational structure 150 and a general motivational structure 160 are depicted. The remainder of operational stages 221-261 differ from the operational stages discussed above in connection with FIG. 1 but are preferably carried out in parallel therewith. As with FIG. 1, however, FIG. 2 is arranged to emphasize inputs and feedback by which this motivational signature feature of the present invention is made continuously adaptive in order to perform optimally in the inception, development and deployment of innovation.

The operation of the motivational signature feature of the invention begins with a definition of motivational drivers and/or award options and parameters 1121 which may be or be the same as default values. This definition is the basic starting point for customization of motivational options and parameters and should be the same for all employees and maintained until altered as a matter of business management policy largely independently of the invention. This maintained policy with minimal connection with the operation of the invention is depicted in FIG. 2 by the lack of any other operation being performed in the other operational stages of FIG. 2 other than the feedback loop passing through some stages of the management element at stages 231-251 which represents some possible degree of manual reaction to adaptive behaviors of the motivational signatures over the population of employees/individuals or groups of employees/individuals. For example, if a single motivational signature (with some possible degree of individual variation) was developed for a large proportion of the employees of a business, management could decide to modify the default options and parameters to conform thereto to thereafter become the benchmark for other adaptive modifications for particular individuals. Again, it is considered to be a preferable management practice (but certainly not necessary to the successful practice of this feature of the invention) to have a standard motivational incentive policy applicable to all employees but which can then be tailored to individuals as employee performance and the efficacy of changes may warrant. It is also considered to be desirable to provide for initial modification in regard to individual employees to accommodate the results of employment negotiations and the like. Therefore, it should be understood that the definitions of award/reward options and parameters may include individual default motivational options and parameters as well as group-wide (e.g. to reflect differences in incentives for groups such as a research group or development group) or business-wide defaults.

In any case, the initial and/or default motivational incentive options and parameters are reported, possibly discriminating if initial values are the same as default parameters as illustrated at 1141, as indicated at 1161. Referring now also to FIG. 2A, it is assumed that these default motivational driver award options and parameters are archived as a default motivational profile and provided as an input to a motivational signature diagnostic system 1250 (so-called because information regarding motivational drivers collected from individuals and groups of individuals will preferably include information regarding the perceived efficacy of the motivational driver and reward options and parameters 1121 to which the individuals are exposed at 1161). The archived motivational profile may, preferably, also track all of the diagnostic tools information and motivational driver selection from inception through the current stage or development and/or deployment of each project or innovation.

This motivational system diagnostic system also receives inputs from individual employees, preferably from initial and/or periodic surveys 1241 such as may be assembled from current answers 1265 to queries 1221 about what motivational drivers they prefer, individually or collectively. For example, an employee might be asked whether they would prefer a cash award or additional (e.g. departmental) funding and/or additional paid time to work on development of their ideas or those of others. The answers may be collected and conveyed by, for example, an on-line submission form, a hard copy submission form, a telephone submission form, an interview or the like collectively referred to and depicted as conduits 1299. This diagnostic tool is used to assess the preferences of users on a spectrum of intrinsic through extrinsic motivational drivers. This information is used to form an initial motivational signature 1341 which is archived as a custom motivational driver definition 1351. This information is also fed back and published at 1161 through a comparison operation 1141 if found to be different from the motivational driver definition established at 1121, as discussed above.

Inputs are also provided from the innovation signature system of the invention which will be described in detail below with reference to FIGS. 3 and 3A and from a post-reward diagnostic 1621 and survey 1643 of driver selections which is fed back from an evaluation of effects and evaluation of perceived effects of particular motivational drivers (as will be described in detail below). The difference between inputs 1221 and 1643 is subtle: the former (1221) surveys the users for statements regarding the reward they want or expect if desired behavior is completed while the latter (1643) is a diagnostic tool used after a reward is made to better understand the user's stated preferences after a reward is made for performance and completion of a desired behavior. Such a process allows an adaptive refinement of motivational drivers which reduces the effects of any bias in the employees statements of motivational driver preferences (which are usually inherent therein). These inputs are used to develop a current motivational signature 1341 (e.g. as a possible modification of the immediately prior motivational signature) for the employee or group of employees which will be applied at the next occurrence of completion of a desired behavior 1421 which is also fed back and published at 1161 if different from the initial motivational driver definition established at 1121 and the immediately prior motivational signature 1341.

More specifically, until a first occurrence of a desired behavior, the only inputs which exist are the current (default) definition of motivational drivers 1121 and the results 1241 of a diagnostic survey 1241 which may be used to adjust or refine the current definition of motivational drivers for an individual employee or group of employees based on their stated preferences and perceptions of rewards which they believe will provide optimal motivation for desired behavior. In general and as a practical matter, the initial state of the motivational signature definition 1341, if different from the current general policy of the business as defined at 1121, will be negotiated with the employee at the time other conditions of employment are agreed upon which will, in effect, serve as an initial iteration of the diagnostic answers and survey 1221, 1241 and may result in a custom motivational driver definition 1351 which will serve as a current motivational signature 1341. This definition/signature may be refined by further iterations of the diagnostic survey, as described above.

The current motivational signature 1341, upon completion of the desired behavior 1421, then determines the reward or other motivational driver delivered to the employee, as illustrated at 1541 (at the level of the motivational system 140) and 1521 (at the level of the employee 120). The employee is then provided an opportunity to express a reaction to the reward or motivational driver as a post-reward diagnostic answer 1621 which is collected and summarized as a post-reward survey 1643 and evaluated to determine if the motivational signature definition is optimal or not. If not, indicated changes are fed back to further refine the motivational signature definition at 1341. This process allows assessment of the impact of rewards on future motivation and determination if there are types or levels of rewards which have little impact for an individual. Thus, the motivational signature system in accordance with the invention provides for implementation of a general policy (at 1121) with provision for refinement thereof; the refinement being based upon initial employee negotiations or employee feedback, individually or in groups, based on general perceptions of effectiveness of the current motivational signatures and policies to produce desired behaviors and further refinement based on employee reactions, individually or in groups, to rewards or other motivational drivers delivered in response to completion of desired activity. Thus the management of motivational policies and signatures in accordance with the invention provides for continual feedback at several levels to maintain the effectiveness of the motivational management system at near-optimum levels by improving delivery of motivational reward/drivers of most interest to the employee; benefitting the business and employee alike.

Referring now to FIGS. 3 and 3A the innovation signature management system of the invention will now be discussed. In general, this aspect of the overall autonomic management system allows tracking of the abilities, expertise and contributions of individual employees in order to optimally manage their deployment in regard to the conception and development of innovation. In FIG. 3, the stages of operation 131-136 are depicted as columns and portions of the environment of the innovation signature system 170 are depicted in rows, including the general motivational structure 200 described above with reference to FIGS. 2 and 2A.

It should be understood that both FIG. 3 and FIG. 3A (which presents portions of FIG. 3 in greater detail and some variations which may be preferable in some applications) are both substantially simplified in the interest of clarity. In general, there are many aspects of personality, talent expertise, interest and the like which may have a bearing on the development of an innovation profile or signature of a particular person or employee which may have a bearing on the situation and circumstances into which the person or employee may be deployed most efficaciously.

Categories of information which are presently considered preferable to collect may include innovative motivational signatures, a contribution profile, contribution performance, an innovation profile, an activity profile and organizational “citizenship”. An innovative motivational signature may include current interests, historical interests and both current and historical motivational signatures as described above in connection with FIG. 2. These sub-categories of information allow an assessment of an individual's relative self-motivation relative to particular technologies, interest areas, subject matter and the like. A contribution profile is principally concerned with the nature and number or frequency and nature of innovation submissions. That is, innovation submissions are not only tracked in number for particular employees to determine the level of initiative of the employees but it is considered to also track the relative numbers of innovation submissions in at least the sub-categories of innovative ideas, problem recognition, solutions to recognized problems, re-use of prior innovation and autonomics (e.g. the way in which people have made submissions that affect the system of the invention). Similarly, the category of contribution performance should allow evaluation of both the quality and quantity on innovation activity of an employee, such as number of ideas referenced as foundational, number of times the employee's's ideas are selected for presentation, the number of ideas which are implemented by the business the number of patent applications filed, the number of patents awarded and other types of recognition of an employee's recognition for contributions to the business. The information collected for the innovation profile category of information involve the nature of the potential impact of the innovation(s) submitted by the employee and with which the employee is most comfortable and creative. For example, the principal submissions of a particular employee may be incremental, evolutionary or radical (i.e. this may express the “size” of the “big picture” which is characteristic of the employee's thought processes). It may also be useful to track whether the submissions or projected submissions concerning the business are directed horizontal, inter-organizational applications or vertical, intra-organizational applications. It is considered to be preferable that the specific types of information collected for the innovation profile be chosen to cover a spectra of different qualities of innovation such as may be expressed as a dimension of a multidimensional matrix or a point on one of potentially may vectors. That is, each of the above groups of examples represents a dimension of a multi-dimensional matrix or a vector among potentially many such dimensions or vectors to categorize the innovation profile of an individual. The activity profile may include the number of votes (e.g. the number of times an employee has rated a submission by someone else) submitted, the number of items reviewed (e.g. the number of times an individual employee has commented on or collaborated upon an idea), and the like. Organizational citizenship should preferably include current and historical administrative placement within the business organization, projects in which the employee participated and volunteer participation and activities. It should be understood that the above preferred types of information from which the innovation signature is derived are only intended to be exemplary and many other types and organizations of data may be preferable in particular applications, as will be evident to those skilled in the art in view of the above discussion. Further, while the above types of data do not all appear in either of FIG. 3 or 3A, all categories noted above except the innovative motivational signature (which may be collected in connection with development of the motivational signature as discussed above, portions of which data have utility therein) appear in FIG. 3A while FIG. 3, as a matter of convenience and clarity of illustration as well as indicating similarities of handling of the respectively illustrated categories of information, divides such information as current interests historical interests, reward preferences and reward history; the latter two categories generally corresponding to the innovative motivational signature category of information discussed above. Again, it should be understood that the categories mentioned as being deemed preferable by the inventor at the present time are not at all critical to the practice of the invention but should be chosen in view of the business and business environment to which the invention is applied. It is only necessary to collect sufficient data and provide an organization of that data sufficient to adequately form a characterization of likely innovative contributions an individual is likely to make when placed in a given environment within a business. It also follows that the complexity of the organization of data need only be commensurate with the organizational complexity of the business and the range of qualities of environment that may exist within it since the basic goal of the innovative signature management aspect of the invention is to allow optimal placement of respective employees within the business organization to support the highest levels of innovative activity.

The innovation profile aspect of the invention preferably provides for collection of the data upon which it operates from both a survey of the employees and from direct and/or independent observation of employee performance in the behavior stage of operation 131. As with the motivational signature data and diagnostic surveys discussed above in connection with FIG. 2, data 3731 supplied by employees is useful, especially in terms of employee morale and personalization of profiles in a fine-grained manner but may not be entirely realistic or accurate and, in any cases, is subject to projection of personal self-image thereon while independently derived data 3231 may not adequately reflect personality factors such as talent, expertise, personal and psychological needs and the like to support optimal management decisions. However, independently collected data 3231 allows a much more complete understanding and evaluation of the much more detailed data 3731 derived directly from the employees. This understanding is also enhanced by rewards and post-reward diagnostic survey records 3201 which, itself, may be regarded as deriving from a combination of employee-provided and independently collected data which, while not necessarily completely objective, tends to be more immediate and certainly less reflective of projected self-image and the like and provides feedback by which the innovation signature may be refined.

The information from these sources is, in tracking stage 132, organized into various categories 3732, as discussed above. It is preferable that each category provide a quantitative descriptor of a distinct characteristic of employee personalty, talent, experience, preference and the like whether as a dimension of a multi-dimensional matrix, as distance along each of a potentially large plurality of vectors or some other construct. These quantitative descriptors may then be merged in a manner not important to the practice of the invention to, in combination, provide an innovation signature 3733 during the profiling phase of operation 133. This information is provided for comparison with a definition of desired innovation activity at comparator 3735 to change motivational drivers which are preferably stored in memory at 3336 or maintained at 3236 to reinforce desired behaviors after analysis of innovative activity records information 3735 in the innovation signature in the innovation pipeline phase of operation 135 in comparison with the definition of desired activity 3334 established during an innovative strategy definition phase of operation 134 and to refine innovation signatures as illustrated in FIG. 3A. The information is also recorded as a historical record as indicated at 5300 of FIG. 8. Of course, if the analysis 3735 indicates no change should be made, motivational drivers are maintained in the general motivational structure 200, as illustrated at 3236 in the optimization phase of operation 136. In either case, the innovation signature should preferably maintain or modify at least motivational preferences (which are fed back as an input to the motivational signature definition 1341 of FIG. 2), an innovation profile and a history of preference and motivational and innovation profiles.

Referring now to FIG. 4, an overview of a preferred integration of the above autonomic management system, motivational signature management system and innovation signature management system will now be discussed. Control of the integrated system 400 is depicted at 4011 in operational period 410 particularly to allow control to be exercised over exposure of the systems included therein to employees and others 1221 during operational period 420. That is, operation 4011 and column 410 are intended to illustrate preparation for exposure to the system such as by transfer of current data for display and the like prior to exposure of all systems 1221 to the ends user in exposure stage 420. As alluded to above, this exposure conveys the current general policies, projects and programs of the business, the individual motivational arrangements and data included in the individual innovation signatures as may be desired for management review, employee performance review and the like as well as for initiating diagnostic surveys as discussed above. This information is preferably divided and suitably limited in regard to the persons to whom it is exposed and to the autonomic management system, motivational signature management system and innovation signature management system, all of which have been discussed above, as depicted at 1031, 3031 and 2031 of FIG. 4. That is, in the profile/tracking operational stage 430, current information about the system an particular innovation being currently managed thereby is provided and historical information maintained at operation 1031 in autonomic management system 100 to support the feedback discussed above in regard to FIG. 1. Similarly. innovative behavior information is provided to the innovation signature management system and the innovative behavior tracked thereby as depicted at 3031 while motivational drivers and incentive information is provided to the motivational signature management system 200 as depicted as 2031. These divisions of information, once operated upon by the respective systems of the invention then collectively form a master profile 4032 which is archived such that portions can be retrieved by the system, as needed. Respective portions of the master profile 4032 are also stored as an innovative signature 3082 and motivational signature 2082. It should be appreciated that while all of these systems contain their own internal feedback arrangements, as discussed above, the autonomic management system 100 and the innovation signature management system 300 also receive additional information in connection with innovative activity such as submission (1222) of an idea or a need (as will be discussed below) with appropriate routing while the motivational signature management system receives feedback from the overall integrated system, as well. In this regard, it should be appreciated that the system of the present invention also allows for the management of innovation directed to not only operation but to actual improvements in the various systems of the invention itself.

Whenever an input or submission is made in regard to a need which can potentially be answered by the business or an innovation, it is entered into and thereafter distributed through the integrated system 400 as depicted by display 4053 in operational period 460. Essentially, both recognized needs and innovation are advertised to employees along with potential rewards/motivational drivers corresponding to respective responses which are thus solicited as depicted by the illustrated output from 4085 to FIG. 2.

It is then determined by the integrated system whether or not the submission itself and/or a response to the particular submission (i.e. if someone submits a need and someone else subsequently submits a solution) should be assigned a reward. If a reward is to be assigned to the submission of an acceptable response, the employees/end-users of the integrated system are then reminded periodically of the availability of that reward as depicted at 1223. If the submission itself is assigned a reward, that information is fed back to the motivational signature system 200 at the tracking phase thereof depicted at 2031. Whenever a reward is to be made a notification is made to all or selected users/employees 1224 as may be desired for additional motivational impact and the impact evaluated by a diagnostic process similar to those discussed above in connection with FIG. 1 and the results also fed back to the motivational signature system for tracking as depicted at 2031.

As a perfecting feature of the invention, the processing of needs submissions alluded to above may be enhanced by the perfecting feature of the invention as detailed in FIG. 4A. The layout of FIG. 4A differs somewhat from FIGS. 1-4 discussed above in that the row 120′ designated “submitter” is actually a subset of end user/employee row 120 which is distinguished from the latter by the behavior 451 of making a submission. Additionally, row 450 designated “innovation site or medium” is also a subset of end users/employees 120 distinguished from the latter by prior submission of potentially matching innovation.

This process begins with a needs submission 4521 which is essentially a presentation of a need of potential customers of the business to which the invention may be applied which it is perceived that the business could profitably answer. Some possible suggestions for solution or implementation may be included in the submission but are not necessary to successful processing of a needs request. The submission is recorded in a submission database 4012 and recommendations for a match with previously submitted innovations is made at 4013. This can be accomplished using any of a variety of known techniques such as matching of terminology, key words, or additional information appended to submissions indicating possibilities for application. If a possible match is discovered, the particulars of both the need and the potentially matching innovation a communicated to the submitter of the need as depicted at 4522 and to the innovation site or medium (e.g. the submitter of the matching innovation). If the submitter does not find the potential match to be an actual match, the need is, nevertheless, communicated in a searchable form to the innovation site or medium, as depicted at 4551 as being a location within the business most likely to be able to provide a solution to answer the needs submission on the theory that such an innovation site would at least be more familiar with possibly matching types of innovation and underlying technologies appropriate to the submitted need. On the other hand, apparently effective matches of need and innovation are also communicated to the matching innovation site where both the innovation and the match to the need may be refined as depicted at 4552. The resulting potential solution is presented to other employees at 4523 for possible further refinement and the result again communicated to the innovation site or medium 450 as depicted at 4573 and possibly refined even further. This result is then forwarded to the submitter of the need 120′ to determine the validity of the result as a solution to the problem. If no match is found or if a proposed match in not considered valid, that determination is fed back to 4521 to be included with the submission. In the same manner, any objection to the solution or clarification of the need may be made by the original submitter and the process repeated until an acceptable solution is as fully matched to the submitted need as possible or the lack of a match finally determined.

Referring now to FIGS. 5-8, preferred methodologies for operating the various systems and overall integration thereof will now be discussed. As noted above, the operation of the AMS system 100 in accordance with the invention will be discussed in connection with FIG. 5, the operation of the motivational signature management system 200 will be discussed in connection with FIG. 6, the innovation signature management system 300 will be discussed in connection with FIG. 7 and the integrated overall AMS system will be discussed in connection with FIG. 8. It should be understood that FIGS. 5-8 supply substantial detail in regard to particular operations depicted in FIGS. 1-4, respectively, while the overall function including the numerous feedback arrangements of FIGS. 1-4 are omitted or only generally indicated in FIGS. 5-8 but must implicitly be considered as overlaid thereon.

Referring now to FIG. 5, a preferred system for management of innovation submissions will be discussed. As alluded to above, this autonomous management system has the capacity not only of tracking the development of innovation submissions during their development but also the capacity to provide integration with submissions of perceived needs and/or opportunities as well as monitoring and adaptively optimizing the autonomous management system itself; functions not previously available in known innovation management systems. Accordingly, separate inputs for organizational ideas 5001, organizational needs/opportunities 5002 and infrastructure ideas 5003 are illustrated but which can be integrated in any combination and even performed concurrently using the same conduits 5004 such as periodic diagnostic surveys, questionnaires, prompts for feedback, independent data capture an the like which can be performed over any desired communication medium 5005, a web site, sametime/instant messaging, off-line e-mail, and telephone links being somewhat preferred as providing messages in a form that can be electronically archived with little, if any, processing. These submissions, collected over time, form a background aggregation of submissions 5006 which may then be organized into a submission database 5007 in a manner not critical to the practice of the invention; many suitable database structures being known to those skilled in the art.

It is considered to be desirable to provide continuous or at least periodic and preferably manual broker screening 5008 of the submissions placed in the database to remove submissions which are of no interest to the business as well as to provide timely acknowledgment and initial substantive consideration of all submissions. Such a response is considered important to maintain employee morale and support for the submission policy of the business to maintain an adequate volume of submissions and innovation within the business. If a submission is rejected at this stage, as depicted by go/no go decision 5009, a message is sent to the submitter/innovator 5010 via e-mail, web site or the like or other communication techniques, preferably electronically and preferably reflecting significant substantive consideration and possibly constructive suggestions for subsequent submissions as well as reasons for the rejection of the submission.

If the submission passes this initial screening, the invention facilitates a more thorough review 5011 which begins with posting of the idea 5012 for peer review 5013. It may be desirable for the peer review 5013 to function as a further screening by a panel, as illustrated by a dashed line, which could vote thereon (5015) to possibly reject (5016) the submission, in which case a message, as discussed above, would be sent to the innovator. The present invention preferably may also facilitate collaboration 5014 in response to such a rejection and such collaboration may modify or further develop the submission an reinsert it in the innovation development process (e.g. at development operation 5017), also facilitated by the present invention. On the other hand, it is considered preferable, if the submission has passed broker screening and thus presumably contains a modicum of merit relevant to the business, to provide for at least the possibility of some development or at least to consider doing so before rejection even if rejected at 5016. Therefore, the current state of the innovation/submission is documented as illustrated at 5017 (even if rejected at 5016) and it is determined at 5018 whether or not the idea/submission is to be further developed. If so, the process loops back to collaboration 5014 and the originator is notified (5010) thereof. After collaboration 5014 to provide some arbitrary degree of further development, the current state of the idea/submission is again documented at 5017 and it is again determined whether or not to further update the idea/submission at 5018. This is a decision from a user whether or not to re-enter a submission and reset its voting if deemed appropriate.

If it is determined not to update (or further update) the idea/submission, a series of operations generally indicated at 5020 are preferably performed. If the submission is not to be updated, no change is made in the submission record as indicated at 5021 and the submission remains in the innovation portfolio (perhaps marked as dormant). If, on the other hand, the submission is to be updated or revised and re-submitted, as determined at 5018, it is deemed preferable (e.g. for uniformity of treatment to support morale and the like) to submit a request for reset of the peer voting, as illustrated at 5022. This request is reviewed and a determination is made as to whether or not to reset the voting at 5023. If the vote is not to be reset, the process branches to 5021, described above, and no change is made. If desired, this action can halt the update/revise process. If the reset is approved, the reset is performed at 5024 (preferably with review by a person with administrative or managerial authority) and the submission is re-entered into the system at 5012. As will be described below, however, other routes (e.g. managerial review and peer adoption) are provided by which a submission can be re-entered into the system, as well.

It should be understood that it is preferred to allow an idea to be elected even while in the process of being collaborated upon. In other words, progress achieved through collaboration may be sufficiently encouraging to support election even before collaboration is completed and the final result of collaboration becomes known. If an idea is initially or eventually elected (5031) a final review and development process generally indicated at 5030 is performed. This includes documentation of the innovation as being a selected file as depicted at 5032. These files are then periodically reviewed by an innovation broker (5033) who then is teamed with the submitter/innovator to prepare the innovation for presentation to persons charged with making major decisions of the business, as depicted at 5034. More detail in regard to the innovation may be needed in this process and may result in communications being communicated through the system of the invention as depicted at 5010. The thorough review and final development performed in this preparation of the innovation for presentation may reveal problems not previously discovered and may result in rejection of the innovation even at this late stage. However, if the innovation is not rejected, it is presented to the leadership of the business at 5036 and a final go/no go decision is made at 5037, leading to either implementation 5038 or deferral 5039.

Referring now to FIG. 6, the preferred motivational signature management system operation will now be described. As described above with reference to FIG. 2, the motivational signature system portion of the present invention is principally directed to the development of an arrangement of motivational drivers on both a group basis and a fine-grained personal basis and in an adaptive manner in order to maintain a high level of innovative motivation over a population of employees of a business to which the invention may be applied. Support of such a function is principally based on collection and aggregation of data, principal sources of which in the environment of a business and personal motivation in regard to activities therein is clearly subject to significant degrees of bias. Further, in the context of the overall integrated innovation management system of the invention, the information needed to support this function is, in large part, closely related to particular innovative activities and thus closely related to information useful in developing innovation signatures for employees and groups of employees. Therefore, it is considered preferable to develop such data over a range of circumstances and over time in order to discern more accurate motivational signatures.

FIG. 6 depicts preferred sources of motivational data in two groups: motivational signature inputs 6001 and Innovation signature inputs. It will be recalled that FIG. 2 also indicated data input in accordance with two different circumstances: answers to an initial or periodic diagnostic survey and answers to a post-reward diagnostic survey. It is to be understood that both groups of inputs illustrated in FIG. 6 may be utilized for either of the diagnostic surveys of FIG. 2.

The group of motivational signature inputs 6001 preferably include but are not limited to diagnostic survey data 6003, motivational driver selections 6004 and archived motivational profiles from which a motivational signature 6007 in developed as a component of the innovation signature for an employee or group of employees. Current innovative interest data 6006 is also part of the innovation signature data which is considered by the motivational signature management system. It is considered preferable to include current innovative interest data since an employee should, at least in theory, be more self-motivated to pursue a current personal interest while enhancement of motivation for such pursuits may be more likely to involve different types of motivational drivers in different degree than for other innovative pursuits to be similarly enhanced. For example, it has been found, using the invention, that employees principally involved in research are most strongly motivated by increased funding for current and anticipate projects than in personal rewards, possibly due to the increased sense of security for their positions and the possible availability of increased compensation through overtime and the like.

The other inputs 6008-6012 are also common to the development of an innovative activity profile which is automatically generated from historical data in accordance with the invention. It will be appreciated that the totality of the information included in inputs 6008-6011 substantially corresponds to the information included in inputs 3732 of FIG. 3 and includes organizational citizenship information 6012 omitted from FIG. 3 for clarity (and the fact that, in practice, it may be changed or updated less frequently. These data components preferably include, but are not limited to a contribution profile 6008, a contribution performance record 6009, and innovation profile 6010, and activity profile 6011 and organizational citizenship 6012. The motivational signature 6007 (which is derived from inputs 6001 (e.g. 6002-6004)) and the current innovation interests data 6006 (preferably reflecting general categories of innovation such as radical, incremental or evolutionary innovation or innovation which may be implement within, for example one-month, one year or five year or very futuristic time spans) are input to the innovation signature diagnostic tool 6015 through conduits 6014 such as were discussed above in connection with conduits 5004 of FIG. 5. Other inputs from innovative activity profile 6013 may be directly input thereto. It should be understood that the diagnostic tool substantially corresponds to the elements 1221, 1241 and 1341 indicated by dashed line 1250 in FIG. 2. This information is then processed as indicated at 6016 to develop an innovation signature 6020 comprising a (possibly adjusted or changed) list of motivational preferences 6021 which may include fixed initial rewards 6030 and/or value or impact based rewards 6040, innovations profiles 6022 and an archival history of those parameters. The processing performed is not critical to the practice of the invention and may be altered, possibly adaptively, to enhance the degree of motivation and matching of incentives (e.g. time off, service vouchers, departmental funding or other resources, recognition and other publicity and the like) to employee responses as the biases inherent in the original data are identified and quantified based on a comparison to actual effects. However, it is contemplated to be preferred that processing similar to a trade-off analysis with quantification of the importance of each incentives which may be relatively simple since only motivational preference characteristics (such as currently preferred drivers including but not limited to time off, service vouchers, increased departmental funding and the like) are of interest in this system of the invention or as complex and detailed as may be considered to be justified. The motivational preferences 6021 may then be used, upon completion by an employee of an activity which the business wishes to encourage as discussed above in connection with FIG. 2, to determine an initial award and/or a value-based or impact-based award for that employee.

Referring now to FIG. 7, it will be recognized that FIG. 7 is substantially a subset of FIG. 6; principally omitting sources of information specific to motivation and retaining sources of information of relevance to innovative performance preferences and characteristics of interest in this system of the invention. Therefore, the constituent elements and their organization shown in FIG. 7 need not be further discussed individually. However, it is important to note that for collecting the current motivational profile 6004 in regard to developing an innovation signature for each employee which is to be used for determining optimal placement of the employee within the organizational structure of the business using the invention, that, in addition to diagnostic surveys 7002, similar to those discussed above discussed above, information regarding employee interests and preferred activities be collected as responses to menu selections which are specific to particular activities and organizational division of the business. The processing at 6016 in FIG. 7 should be preferably somewhat similar to that of FIG. 6 but may be further simplified in accordance with the reduced data set and may apply somewhat different expressions to be evaluated (e.g. applying different weights to particular types of information) since the result of interest is finding a match of an employee to a location within the organizational structure of the business which will optimally support creative and innovative activity.

Turning now to FIG. 8 there is shown a detailed implementation of an autonomic innovation infrastructure comprised of the three components described above in connection with FIGS. 1, 2, 3, 5, 6 and 7, namely, the autonomic system for managing innovation (FIGS. 1 and 5), the system for establishing and managing motivational signatures and recognizing motivational drivers (FIGS. 2 and 6), and the system for monitoring and managing innovation signatures (FIGS. 3 and 7). The interaction of this autonomic innovation management infrastructure with a business environment in which it is employed has been discussed above in connection with FIG. 4. Thus, the following discussion of FIG. 8 will also serve to summarize the above discussions of individual systems and their integration into an overall innovation management system which also optimizes motivation for innovation and employee deployment in an adaptive manner to support maximal innovative performance within a business.

Input: At the top of FIG. 8 are the components for handling submission 100 of inputs to the system. There are various types of ideas which the user might submit. An idea may be classified 105 as a new product, process, or solution. A Need/Problem 110 is a problem that needs a solution. A Need/Opportunity 115 is an opportunity that would result in increased revenue or decreased cost. A Solution 120 is when the end-user goes into the system, identifies a problem or opportunity, and presents a solution. A Reuse 125 is when the end-user goes into the system and applies a previously used idea to a different problem or opportunity. An Infrastructure Idea 130 is an idea that provides a change or enhancement to the infrastructure shown in FIG. 8, which may result in modification of one or another aspect of the implementation. It is this characteristic of the invention that is the source of the name “autonomic”, which is understood in the present invention to mean self-correcting and self-optimizing.

Conduits: The inputs to the system are channeled through a variety of conduits 200. Conduits are the ways in which the community of end-users (i.e. the employees and managers who comprise the enterprise) is able to submit information into the system. For example, there may be a web site 205 that is a secure submission forum which takes place on the corporate Intranet. Another conduit may be Sametime/Instant Messaging 210. Instant messaging gives the user of the system the ability to submit an idea, to comment on an idea, or interact with the system using an instant messaging methodology that is able to mirror the functionality available at the web site 205. Idea submissions may also be generated Off-line 215 and sent by electronic mail in such a way as to provide the end user the ability to submit an idea or interact with the system remotely from a computer not directly connected to the system. For example, an end-user could complete an idea submission form or response form while on a plane and send it by electronic mail, perhaps even from the airplane. Alternatively, submissions may be made by phone 220. There are two types of phone submissions. First there is a phone submission form which allows the end-user to speak into a voice-recognition system, which interacts with the user to fill out the form. Secondly, the user may also talk to a live operator who then subsequently dictates or types the input into the system. There are may other conduits 225 that can be set up for use with the system. Some of these conduits include dedicated devices, kiosks, handhelds, and similar input devices evident to those skilled in the art.

Display/exposure and Collaboration: Once the ideas have entered the system through one of the conduits, they are then aggregated 305 at the back end into one of several database options. The Innovation Submission database 310 is a dedicated database, which tracks the innovation submissions and all conversation strings surrounding them. The main site 500 is the front end for the IT portion of the infrastructure. On the site there are several different paths and actions which the end-user community can execute upon. One end-user can post 505 an idea or need on the main site 500. One end-user submits another idea, going through one of several conduits. Once the idea reaches the main site 500 it is open for peer review and collaborative assessment 510. Collaboration 515 is a key portion of the peer review and collaborative assessment 510, where the end-user community has the ability to comment on the ideas submitted by others, identify duplicates, submit enhancements, flag an idea for intellectual property review and provide other useful information. Peer voting or collaborative assessment included in 510 is where the community is given the ability to weigh in on the value of the idea based on a set of measures reflecting value to the enterprise. For example, measures could include business value, technical merit, cultural value, and general value. Ideas can also be judged based on the number of informal implementers, a metric that is also collected by the system.

Rejection of a submission: The end-user community also has a voice in rejecting 525 an idea. The reasons for rejection of an idea can include: duplicate idea, inappropriate content, or other legitimate reasons. Finally, a search engine 530 provides a methodology for the community to navigate through a vast collection of both ideas and needs. This search engine can pull from ideas and needs which are stored at the main site 500 or, if connected, it can also draw from ideas available externally.

Needs Management System: Substantially in parallel with main site 500 is the needs management system discussed above in connection with FIG. 4A. Needs submission information can be handled in much the same manner as innovation submissions to the point of placement in innovation database 310 and supplied therefrom to the needs management section 8000. Submitted solutions 8200 can also be handled in the same manner. As discussed above, the invention provides for solution suggestion generation 8300 from among the innovation included in the innovation submission database 310 and also facilitates evaluation by users/employees of both submitted solutions and generated suggestions, as illustrated at 8500. Matches found or developed in this manner are then output and handled, possibly with further development, in the manner of innovation submissions. Validation of a match and further development preferably can occur in parallel

Innovation Portfolio tracking: The electronic output 600 from this site serves many purposes. Primarily, it can be used for evaluation purposes or to document innovation performance. The output includes an electronic file of all activity associated with a given idea or need. The initially developed idea or need 605 may spark subsequent conversational strings 610, which include all discussion and suggestions for enhancement or modification of the idea. This information is recorded as text inputs. Peer review or Collaborative Assessment ratings 615 include the results from the collaborative assessments where members of the community rate/vote/endorse/assess a given idea.

Selection of top ideas: At the selection stage 700, ideas are selected for further management review, either by an automated analysis of the results of peer review 710 over a period of time, or by selection by certain members of the community who have been given authorization to put ideas on a fast path 705. Preferably, peer review 710 includes three status levels: peer voting selection, management review and informal usage (e.g. the number of employees, departments or projects which implement the submission, with or without further development); any of which may be the basis for selection even if other status levels yield a negative response to the submission.

End-user messaging: An electronic message back to the innovator 810, when an idea has been selected for further management review, is an important feedback component of the system. This component may be satisfied by any of the methodologies of communicating with the end-user or innovator. It could be via e-mail, the web site, phone, instant messaging, etc.

IP Law Integration: Those ideas selected for further management review are also entered into the enterprise's intellectual property (IP) or Worldwise Patent Tracking System (WPTS) 900. Once the idea enters the intellectual property system, IP lawyers and others with administrative access to IP system are able to look at the ideas 905 and determine an appropriate level of intellectual property protection. Following review 905, a decision may be made 910 whether disclosure of the idea should be limited, or a formal invention disclosure 915 should be made. Other designated members of the community can preferably also trigger an intellectual property law review.

Innovation Portfolio Routing: In a development stage 1000, the first step is to create a file called an “Innovation Portfolio” of selected ideas 1005, which includes the key data. This file can include data from each idea and its respective conversation strings. Once the necessary data for an idea is aggregated, the idea is reviewed 1100 by a panel of subject matter experts or other team deemed appropriate to review these ideas. Then this team or another team 1200 is charged with prepping the case and building a portfolio for the given idea or need. Upon completion of prepping the case and building a portfolio, the review team 1200 would be expected to do in initial (e.g. expedited) analysis or assessment of the idea to determine whether or not to go forward 1205. For example, following completion of the portfolio preparation, if they realize that there is a fatal flaw the idea can be killed. If the decision 1205 is to go forward with the idea, a suitable presentation 1300 would then be made to process owners (e.g. if the idea is for modification of a business process of the enterprise) or other stakeholders for decision. Once the stakeholders have had an opportunity to review the feasibility and potential business impact of the idea they would make a final go/no-go decision 1305 before going to the implementation stage.

The innovator and the review team will have developed a proposed set of next steps for pursuing implementation. The stakeholders may commit to developing and implementing the idea 2000, or they may decide that there will be no immediate next steps taken 2005.

Two key components of the autonomic innovation infrastructure are the Motivational Signature and the Innovation Profile discussed above. The inputs 5005 for the innovation and motivational signature are provided via the same conduits as ideas and needs. These inputs are the responses to questions about the specific motivational and innovative orientation of the individual user. The innovation signature diagnostic tool 5010 analyzes the individual's innovative behavior in light of their motivational and innovative preferences. The information collected from the innovation signature diagnostic tool is then used to process 5015 the individual's innovative signature. The innovative signature charts the individual's innovative and motivational characteristics. The innovation signature 5000 takes into consideration an individual innovator's innovative interest, innovative strengths, innovative motivational drivers, desired environment, desired infrastructure, desired management structure, and other preferences.

An individuals motivational signature 5100 can be defined as those motivational drivers that consistently lead the individual to perform certain types of behavior. These can change over time, and consequently the more responsive the motivational signature is to these changes the more likely it is that the system will provide optimal behavioral reinforcement and change. The innovation profile 5200 is the record of an individuals innovative behavior over a period of time. A history of preferences and profiles 5300 is a compilation of both the innovative and motivational preferences and profiles of an employee. The combination of the motivational signature 5100, innovation profile 5200, and history 5300 represent the individual's innovation signature 5000. This information can be used for business intelligence to better understand the drivers of innovation and to provide trend analysis of both behavior and preferences.

The Innovation Pipeline Analyzer 6000, illustrated in greater detail in FIG. 8A, includes a real-time Innovation Pipeline Dashboard 6100, whose primary function is to analyze the pipeline of information flowing through the enterprise's ecosystem at any given time. This can allow the company to understand better if the pipeline is comprised of incremental, versus evolutionary versus radical ideas. It also allows the company to analyze their innovation pipeline based on any number of additional metrics. The Innovation Pipeline Analyzer 6000 also includes historical pipeline displays 6200, which allows the company to look back in time a few months, or even a few years, to see what the pipeline has been at any given time. A further component of the Innovation Pipeline Analyzer 6000 is the Innovation Portfolio 6500, which consists of all innovations, including those ideas which were leveraged many years ago as well as ideas that will still not be able to be leveraged for many years to come. The portfolio can be characterized based on time horizons, on certainty, and on those metrics which are of greatest concern to the organization.

The innovation pipeline analyzer provides a competitive benefit to an organization by providing business intelligence data featuring real-time and historical innovative behaviors. The information provided by the innovation pipeline analyzer includes but is not limited to types of innovation (e.g. radical, evolutionary, incremental), times to implementation (e.g. short term, long term, futuristic), and the like. This data can be used to provide information, in real-time or short time intervals, on the types of innovations that are in process within the organization and the state of development and progress of individual projects or combinations of projects. The data can also be used to provide historical tracking of innovative behavior and also used in the aggregate to allow consideration and analysis of the overall innovation portfolio of the organization.

The innovation pipeline analyzer thus provides access to information concerning aspects of the innovation processes within an organization by providing an opportunity for comparison of the historic organization portfolio 6500 and current organization portfolio 6500′ and the historical innovation pipeline 6200 and current innovation pipeline 6200′ with objectives (e.g. manually or by use of a comparator or a combination thereof as depicted at 7400) of the portfolio 7301 and the pipeline 7302. For example, the innovation pipeline analyzer can report information in a form for facilitating balancing the types of innovation, planning of introduction of new products or improvements, planning of introduction of new lines of products or services, sustaining growth and industry share or position, coordinating related products or technologies and the like as well as maintaining progress of development of projects and avoiding extended periods when research and development innovation projects are not brought to completion to enhance to revenues of the organization particularly by updating of incentives 7420 and other possible managerial adjustments.

More generally, the information from the innovation pipeline manager 7000 can also be used for critical decision making and management. In the Automated pipeline manager, the managers or leaders of the organization or departments therein can set specific objectives or goals. Once these objectives or goals have been created, and input, the automated innovation pipeline manager is able to compare the pipeline contents and the objective or goal. If there is misalignment, the system will be enabled to make (or recommend) predetermined changes within managerially set parameters 7410 in order to obtain additional innovation or innovative activity to correct the misalignment and more closely approach the input objectives and goals. If the misalignment is outside given parameters, the system will inform management 7420 in order to take corrective action.

To provide such functions, the Automated Pipeline Manager 7000, illustrated in greater detail in FIG. 8B, includes a Management Innovation Pipeline Objective 7100. In order for management to determine their innovation pipeline objective they must make a decision on what metrics they need to focus. For example, if the management is focused on innovations which will have an impact in the upcoming year, they may want a pipeline which is heavy on short-term innovation, whereas if they are concerned about the longer term health of the company they may prefer building their pipeline of with innovations having five to ten year time horizons. Corporations can also make a decision regarding where their pipeline focuses. For example, if the company manufactures of heavy machinery and consumer electronics, and consumer electronics becomes less lucrative for the business, they will likely increase their objective for heavy machinery innovations.

The Automated Pipeline Manager 7000 also includes a Management Innovation Portfolio Objective 7200. Company management will also make decisions about their innovation portfolio allocation. For example, if they come to realize that there will likely be erosion of the consumer electronics market, they will likely want to decrease their innovation portfolio objective for consumer electronic innovations.

The pipeline/portfolio review process 7300 is an automatic system to analyze the innovation pipeline to ensure its alignment with the strategic portfolio objectives. Upon completion of the review, an analysis 7400 is made to determine if the pipeline is aligned with the portfolio objectives. The system subsequently sends an electronic update 7410 to management advising them of the alignment or lack of alignment. This message can be sent or not sent, depending on threshold set by management. If the pipeline is out of line with the portfolio objectives, the system can automatically update 7420 the incentives and rewards to drive those types of innovations necessary to bring the pipeline into alignment with the portfolio objectives. This can be done as a manual process, or can be driven automatically by the system.

In view of the foregoing, it is seen that the overall integrated system provides for management and adaptive optimization of virtually all aspects of the innovation process including maximization of motivation of innovative activity and supports optimal deployment of employees within a business organization in consideration of their talents and other characteristics relevant to innovation as well as facilitating review and evaluation of the innovation portfolio of a business and accommodating needs submissions and their evaluation and matching to technology in the business portfolio. It will be appreciated that the preferred form of the autonomic management system in accordance with the invention provides not only for handling and development of submissions in regard to innovations or other types of submissions which may be of interest to the product of an organization but submissions in regard to the management infrastructure, as well, while providing adaptive modification of the infrastructure through ongoing assessment, diagnostics and feedback which may be autonomous within certain freely chosen parameters while requiring human intervention (with or without accompanying recommendations) for changes outside those parameters. Likewise, the motivational signature management system adaptively provides optimal motivation for individuals to engage in and complete particular desired behaviors, motivational or otherwise, which is useful in and of itself while potentially improving the performance of any management system in regard to innovation or any other endeavor. Moreover, while an innovation signature (or signature for any other type of performance criteria) may also be useful in and of itself for supporting optimal deployment of an individual or employee within an organizational structure for enhanced performance therein, is also useful in combination with other systems of the invention such as to enhance the adaptive behavior of the motivational signature management system and/or the autonomic management system of the invention, as well.

While the invention has been described in terms of a single preferred embodiment, those skilled in the art will recognize that the invention can be practiced with modification within the spirit and scope of the appended claims.

1. An integrated autonomic innovation infrastructure comprising, in combination,
an autonomic management system and infrastructure comprising
means for inputting submissions in plural categories to said autonomic management system, at least one category of said plurality of categories relating to said infrastructure of said autonomic management system, and
a feedback path for implementing submissions based on results of evaluation performed in one or both of a first evaluation path and a second evaluation path corresponding to said at least one category and said other categories, and
a motivational signature management system comprising
means for developing a motivational signature from said information regarding motivational drivers,
means for collecting information regarding responses of said individuals or groups of individuals to rewards presented upon completion of desired behavior, and
a feedback path for refining said motivational signature with said information regarding said responses to said rewards.

2. The infrastructure as recited in claim 1, further including
a pipeline analyzer, said pipeline analyzer including
means for storing and selectively accessing innovation portfolio information, and
a comparator for comparing said innovation portfolio information with an innovation pipeline objective.

3. An infrastructure as recited in claim 2, wherein said pipeline analyzer further comprises
a pipeline manager, said pipeline manager including
a comparator for determining alignment or non-alignment between innovation portfolio objectives and innovation pipeline objectives, and
means for altering motivational incentives to correct non-alignment detected by said comparator.

4. The infrastructure as recited in claim 1, further comprising
means for distributing information regarding said submissions and providing peer review and assessment.

5. The infrastructure as recited in claim 1, further including
means for providing collaboration in development of a said submission.

6. The infrastructure as recited in claim 1, further comprising
an innovation signature management system comprising
means for developing an innovation signature for said individual from information representing innovation activity, innovative interests, motivational preferences and reward and survey records,
a comparator for comparing said innovation signature with a definition of desired innovation activity, and
a feedback path for said motivational driver information to said reward and survey records for said individual.

7. The infrastructure as recited in claim 6, wherein said innovation signature is input to said means for developing said motivational signature.

8. An integrated autonomic innovation infrastructure comprising, in combination,
an autonomic management system and infrastructure comprising
means for inputting submissions in plural categories to said autonomic management system, at least one category of said plurality of categories relating to said infrastructure of said autonomic management system, and
a feedback path for implementing submissions based on results of evaluation performed in one or both of a first evaluation path and a second evaluation path corresponding to said at least one category and said other categories, and
an innovation signature management system comprising
means for developing an innovation signature for said individual from information representing innovation activity, innovative interests, motivational preferences and reward and survey records,
a comparator for comparing said innovation signature with a definition of desired innovation activity, and
a feedback path for motivational driver information to reward and survey records for said individual.

9. The infrastructure as recited in claim 1, further including
a pipeline analyzer, said pipeline analyzer including
means for storing and selectively accessing innovation portfolio information, and
a comparator for comparing said innovation portfolio information with an innovation pipeline objective.

10. An infrastructure as recited in claim 2, wherein said pipeline analyzer further comprises
a pipeline manager, said pipeline manager including
a comparator for determining alignment or non-alignment between innovation portfolio objectives and innovation pipeline objectives, and
means for altering motivational incentives to correct non-alignment detected by said comparator.

11. A system for managing innovation within an enterprise, comprising:
a basic innovation subsystem further comprising a subsystem for gathering ideas from users of said system, a subsystem for review of and collaboration on said ideas by a community of said users, and a subsystem for tracking progress of said ideas through the enterprise from idea generation to idea implementation;
means for developing and maintaining a motivational signature for each said user, said motivational signature identifying an incentive structure optimized for said user;
means for developing and maintaining an innovative signature for each said user, said innovative signature providing a profile of contributions to the system by said user; and
an autonomic management subsystem for using input from said community of users to adapt a process of said enterprise, said autonomic management subsystem further comprising:
means for using said idea gathering subsystem to survey said community of users regarding the value of said process and generate ideas for improving said process;
means for determining whether one of said generated ideas for improving said process is to be implemented, discarded or deferred for possible future implementation, said determining means further comprising:
means for using said review and collaboration subsystem to obtain from said community of users
a valuation of said idea, said valuation indicating a likelihood that implementation of said idea will improve said process, and
a recommendation that said idea be implemented, discarded or deferred; and
means for using said review and collaboration subsystem to obtain from a designated subset of said community of users
an expedited valuation of said idea, said valuation indicating a likelihood that implementation of said idea will improve said process, and
a expedited recommendation that said idea be implemented, discarded or deferred;
means for presenting said valuations and said recommendations to a management subset of said community of users for decision; and
means for receiving and storing said decision of said management subset of said community of users.
